(19) United States
(12) Patent Application Publication
(10) Pub. No.: US 2015/0272129 A1
(43) Pub. Date: Oct. 1, 2015

(54) COMPACTED PESTICIDE FORMULATIONS

(71) Applicants: Miron TESHLER, Ste-Anne-de-Bellevue (CA); Silvia Ivanova TODOROVA, Montreal (CA); ANATIS BIOPROTECTION INC., St-Jacques-le Minuer (CA)

(72) Inventors: Miron Teshler, Ste-Anne-de-Bellevue (CA); Silvia Ivanova Todorova, Montreal (CA)

(21) Appl. No.: 14/433,747

(22) PCT Filed: Oct. 24, 2013
(86) PCT No.: PCT/CA2013/000916

§ 371 Date: Apr. 6, 2015

Related U.S. Application Data
(60) Provisional application No. 61/718,354, filed on Oct. 25, 2012.

(51) Int. Cl. A01N 63/04; A01N 25/06; A01N 25/08

(52) U.S. Cl. CPC A01N 63/04; A01N 25/08; A01N 25/06

(57) ABSTRACT

It is herewith provided a pesticidal composition composing a microbial propaguse (such as a conidia from B. bassiana) and an agriculturally-acceptable carrier (such as kaolin day) provided in a solid formulation obtained by dry compaction. The pesticidal composition can optionally contain a water dispersant (such as starch) as well as a binder (such as xhantam gum). The pesticidal composition doss not contain a surfactant but is nevertheless dispersible in water.

### CROSS-REFERENCE TO RELATED APPLICATIONS

This is the first application filed for the present invention.

### TECHNOLOGICAL FIELD

This application relates to the use of dry-compacted formulations of pesticides for agricultural applications. The pesticidal composition can be used in organic crop production.

### BACKGROUND

Every year more than 30% of the world's plant production—forests, orchards and field production—is destroyed by phytophagous insects. These devastations have brought a massive use of chemical insecticides in the past ten years, which harm the natural equilibrium without providing a long-term solution since chemical pesticides kill beneficial insects and/or pest insects develop a resistance to chemical pesticides.

Abusive pesticides use has negative implications for human health (carcinogenicity teratogenicity, reproduction perturbation, etc.) as well as for the environment. The World Health Organization's latest report states that 220000 people die of chemical pesticides-related causes (cancer, intoxication, etc.). In terms of the environmental impact of chemical pesticides, we can already see the damaging effects on the ozone layer, the contaminated soils, and their ineffectiveness on crops in the long term.

The massive application of synthetic insecticides brought about the occurrence of insect pest populations resistant to most of the products available on the market (arsenic compounds, organochlorine, carbamate, organophosphate and synthetic pyrethrum) with a 2 to 8 years resistance evolution period. Furthermore, the systematic recourse to chemical insecticides contributes to the elimination of the natural enemies of the pest insects such as ladybugs, predatory bugs, lacewings, etc.

The environmental and ecological problems resulting from the use of chemical insecticides as well as the insects resistance to the frequently used products emphasize the importance of developing alternative approaches to pest control. The recourse to biological pest control is an important step towards sustainable development and one of the best strategies available to better protect the environment and biodiversity.

Some specific bacteria and virus strains are already used against the pest insect populations. However, the exclusive mode of infection by ingestion pose the same resistance development risk associated with chemical products. It has been clearly established that the durability of the bacteria Bacillus thuringiensis (Bt) effectiveness is inversely proportional to the intensity of use and that Bt will be a short-term solution.

Pesticides have been specifically formulated for application to crops. However, some of them have been shown to cause unwanted side effects in crops or by the end user. For example, some liquid oil-based formulations have been shown to be phytotoxic for plants. In addition, wettable powder formulations have been associated with exposing the users to particles during the mixing step, causing skin and eyes irritation as well as inhalation problems. Further, some formulations require the use of surfactants to allow the dispersion into water, which, besides producing a foam which disrupts the effectiveness of spraying and may limit the viability of biological pesticides, is also incompatible with organic crop production.

It would be highly desirable to provide a solid pesticidal composition for the delivery of microbial propagules. Such solid pesticidal compositions are preferably non-phytotoxic, limit particle exposure to the end-user daring pre-application steps (e.g., mixing), can be designed for organic crop production and/or can be stored without substantially altering its pesticidial activity.

### BRIEF SUMMARY

The present invention provides a solid pesticidal composition which contains a microbial propagule and an agriculturally-acceptable carrier and is obtained by a dry compaction process. The present invention also provides sprayable liquid containing the dispersed pesticidal composition, methods of using the solid pesticidal composition as well a process for making the solid pesticidal composition.

In accordance with a first aspect, the present invention provides a solid pesticidal composition comprising a microbial propagule disseminated within a dry-compacted water-dispersible agriculturally acceptable carrier. In an embodiment, the concentration of the microbial propagule in the solid pesticidal composition is between about 15% to about 30% (w/w), and in a further embodiment, the concentration of the microbial propagule in the sold pesticidal composition is about 20% (w/w).

In another embodiment the microbial propagule is hydrophobic and is optionally a fungal propagule, such as, for example, a conidia from an entomopathogenic fungus. The entomopathogenic fungus can be from the species Beauveria and, in a further embodiment, from the genus Beauveria bassiana. In an embodiment the concentration of the water-dispersible agriculturally acceptable carrier in the solid pesticidal composition is between about 20% to 85% (w/w) and, in a further embodiment, the concentration of the water-dispersible agriculturally acceptable carrier in the solid pesticidal composition is about 82% (w/w). In an embodiment, the agriculturally-acceptable carrier comprises clay, such as, for example a kaolin clay.

In a further embodiment, the solid pesticidal composition of further includes a water dispersant disseminated within the dry-compacted water-dispersible agriculturally acceptable carrier. In an embodiment, the concentration of the water dispersant in the solid pesticidal composition is between about 2% to about 20% (w/w) and, in a further embodiment, the concentration of the water dispersant in the solid pesticidal composition is about 17% (w/w). In another embodiment, the water dispersant comprises a starch, such as, for example, a corn starch.

In accordance with another aspect of the present invention there is provided a effervescent solid pesticidal composition comprising a microbial propagula disseminated within a dry-compacted water-dispersible agriculturally acceptable carrier, a binding agent, a water dispersant agent a disintegration agent and a surfactant in a further embodiment, the concentration of the microbial propagule in the solid pesticidal composition is between about 18% to about 22% (w/w). In a further embodiment the concentration of the water dispersant in the solid pesticidal composition is between 8% and 15% (w/w) and the dispersant comprises calcium carbonate. In a further embodiment, the solid pesticidal composition further comprises a disintegration agent working with the water dispersant forming effervescent properties wherein the concentration of the disintegration agent is citric acid and is between 20% and 30%,

In a further embodiment, the solid pesticidal composition further comprises a binding agent. In another embodiment, the concentration of a binding agent in the solid pesticidal composition is between about 6% to about 15% (w/w) and the binding agent is cellulose.

In still another embodiment the solid pesticidal composition further comprises a binder disseminated within the dry-compacted water-dispersible agriculturally acceptable carrier. In an embodiment, the concentration of a binder in the solid pesticidal composition is between about 0.5% to about 2% (w/w) and, in a further embodiment, the concentration of the a binder in the solid pesticidal composition is about 1% (w/w). In an embodiment, the binder is a gum such as, for example, a xanthan gum.

In an embodiment, the solid pesticidal composition further comprises a surfactant disseminated within the dry-compacted water-dispersible agriculturally acceptable carrier. In an embodiment, the concentration of the surfactant is between about 0.5% and 5% (w/w) and, in a further embodiment, the concentration of the surfactant in the solid pesticidal composition is about 2.5%. In an embodiment, the surfactants is a detergent such as, for example, tween or polyethylene glycol.

According to a second aspect, the present invention provides an aqueous sprayable liquid formulation for controlling pest. The aqueous sprayable liquid formulation comprises the solid pesticidal composition described herein dispersed in an aqueous solution. In an embodiment, the aqueous solution is water.

According to a third aspect, the present invention provides a sprayable liquid formulation for controlling pest. The sprayable liquid formulation comprises an oil-in-water emulsion of the solid pesticidal composition described herein. In an embodiment, the sprayable liquid formulation is obtained by combining a mixture of an oil and a surfactant to the aqueous sprayable liquid formulation described herein. In another embodiment, the concentration of the oil in the mixture is between about 95 to about 98% (w/w) of the oil. In still another embodiment, the oil is a rapeseed oil. In yet another embodiment, the concentration of the surfactant in the mixture is between about 0.5 to 2% (w/w). In yet another embodiment, the surfactant is a non-ionic surfactant which can optionally provide an hydrophile-lipophile balance (HUB) in the resulting sprayable liquid formulation is between about 8 to about 18 (such as for example about 12). In a further embodiment, the surfactant comprises soy lecithin and/or a combination of Tween 80 and Span 80.

According to a fourth aspect, the present invention provides a method for controlling post. Broadly, the method comprises applying the sprayable liquid formulation described herein to a crop so as to limit or prevent pest growth and/or propagation.

According to a fifth aspect, the present invention provides process for producing a solid pesticidal composition. Broadly, the process comprises a) providing a substantially homogeneous mixture comprising a microbial propagule and a water-dispersible agriculturally acceptable carrier; and b) submitting the substantially homogeneous mixture of step a) to dry compaction to provide a dry-compacted solid pesticidal composition. Optionally, the process can comprises c) formulating the dry-compacted solid pesticidal composition into a tablet. Various embodiments with respect to the nature and the concentration of the microbial propagule, the nature and the concentration of the water-dispersible agriculturally acceptable carrier, the nature and concentration of the optional water dispersant, the nature and concentration of the optional binder have been described herein and can be applied to this process.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 provides a box plot design of the dry-compacted briquettes produced in function of B. bassiana conidia viability (number of germinated conidia per plate). Briquettes were produced using a 0 kg (condition 1), 250 kg (condition 2), 500 kg (condition 3), 750 (condition 4) or 1000 Kg (condition 5) compaction force with a manual hydraulic press.

FIG. 2 provides a box plot of various pesticidal treatments on whitefly distribution (number of larva per branch) in the mid part of the tomato plants. Treatment 1=negative control (water); Treatment 2=positive control BotaniGard 22™WP (4×10¹⁰ spores/L); Treatment 3=BioCeres-WB (1×10¹⁰ spores/L); Treatment 4=BioCeres-WB (2×10¹⁰ spores/L) and Treatment 5=BioCeres WB (4×10¹⁰ spores/L).

FIG. 3 provides a box plot of various pesticidal treatments on whitefly distribution (number of larva per branch) in the low (A and C) and mid parts (B and D) of tomato plants. Treatment 1=negative control (water); Treatment 2=positive control BotaniGard 22™WP (4×10¹⁰ spores/L); Treatment 3=BioCeres-WB (4×10¹⁰ spores/L); Treatment 4=BioCeres WB (6×10¹⁰ spores/L) and Treatment 5=BioCeres WB (8×10¹⁰ spores/L). Panels A and C/S and D are repetitions.

FIG. 4 provides a box plot of various pesticidal treatments on whitefly distribution (number of larva per branch) in the mid part of the tomato plants. Treatment 1=negative control (water); Treatment 2=positive control BotaniGard 22™WP (4×10¹⁰ spores/L); Treatment 3=BioCeres-WB (2×10¹⁰ spores/L); Treatment 4=BioCeres-WB (4×10¹⁰ spores/L) and Treatment 5=BioCeres-WB (6×10¹⁰ spores/L).

FIG. 5 provides a box plot of various pesticidal treatments on thrips distribution (number of thrips per leaf) in cucumber plants. Treatment 1=negative control (wafer); Treatment 2=positive control BotaniGard 22™WP (4×10¹⁰ spores/L); Treatment 3—BioCeres-WB (1×10¹⁰ spores/L); Treatment 4=BioCeres-WB (2×10¹⁰ spores/L) and Treatment 5=BioCeres-WB (4×10¹⁵ spores/L), Panel A shows data obtained from 8 leaves/plant whereas panel 8 shows data obtained from 10 leaves/plant.

FIG. 5 provides a box plot of various pesticidal treatments on thrips distribution (number of thrips per leaf) in cucumber plants. Treatment 1—negative control (water); Treatment 2—positive control BotaniGard 22™WP (4×10¹⁰ spores/L); Treatment 3=BioCeres-WB (4×10¹⁰ spores/L); Treatment 4=BioCeres-WB (6×10¹⁰ spores/L) and Treatment 5=BioCeres-WB (8×10¹⁰ spores/L). Panel A shows data obtained from 10 leaves/plants, whereas panels B and C show data obtained from 12 leaves/plant.

FIG. 7 provides a box plot of various pesticidal treatments on thrips distribution (number of thrips per leaf) in cucumber plants. Treatment 1=negative control (water); Treatment 2=positive control BotaniGard 22™WP (4×10¹⁰ spores/L); Treatment 3=BioCeres-WB (2×10¹⁰ spores/L); Treatment 4=BioCeres-WB (4×10¹⁰ spores/L) and Treatment 5=BioCeres-WB (6×10 spores/L). Results were obtained from 12 leaves/plant.

### DETAILED DESCRIPTION

In accordance with the present invention, there is provided a solid pesticidal composition which contains a microbial propagule and an agriculturally-acceptable carrier and is obtained by a dry compaction process. The present invention also provides sprayable liquid containing the dispersed pesticidal composition, methods of using the solid pesticidal composition as well a process for making the solid pesticidal composition. The solid pesticidal composition described herein is advantageous because it is safe to use on plants (e.g., in some embodiments, it is not phytotoxic), it limits particle exposure to the end-user during pre-application steps (e.g., mixing), it can include a surfactant or a disintegrant, it can be designed for organic crop production and it can be stored without substantially altering its pesticidial activity.

### Definitions

Throughout this application, various terms are used according to their plain meaning in the art. However, for purposes of clarity, some of terms are more precisely defined herein.

Granulation. As used herein, the term “granulation” refers to the act or process of forming grains from a mixture of at least two components. Granulation can be achieved through wet granulation, extrusion or spheronisation as well as dry granulation. The expression “wet granulation” refers to a granulation process which is performed in the presence of a granulating fluid (usually an aqueous liquid or water). The components are usually dry mixed first and than put into contact with the granulating fluid (through direct addition or spray). Afterwards, the granules are formed either by low-shear granulation, high-shear granulation and fluid bed granulation. The granules are then preferably dried and optionally submitted to further processing such as compaction. Alternatively, the expression “dry granulation” (also referred to as “dry compaction”) refers to a granule-making process which is performed in the absence of a granulating fluid. Dry granulation involves the aggregation of particles by high press to form bonds between particles by virtue of their close proximity. Forming granules without moisture requires the compacting/densifying elements. Dry granulation can be achieved by the use of an hydraulic press (to form directly a solid shape composition) or by roller compaction (to form a sheet of material which can be further processed into a solid shape composition).

Compaction. As used herein, the term “compaction” refers to a process for formulating a pesticidal composition in which all the components of the composition are mixed and submitted to a compaction force. In a preferable embodiment, the compaction process is a dry compaction process (either through hydraulic press or roll compaction) where solid pesticidal compositions are obtained through a dry granulation process.

Compaction force. A force (in kg) applied during the compaction process to make a solid form from the powder.

Granule. As used herein, the term “granule” is intended to refer to a formulation consisting of an active ingredient (e.g., a pesticide) combined with a carrier and which has not been submitted to a dry compaction process.

Hardness level. A mass (in kg) used to measure the crush resistance of end product solid formulation.

Propagate. As used herein, the term “propagule” is intended to refer to a material that can used for the purpose of propagating an organism to the next stage in their life cycle via dispersal. The propagule is usually distinct in form from the parent organism. Microbial propagules can be produced by fungi, protozoa and bacteria. Bacterial and fungal propagules produce microbial spores. As it is known in the art, “spores” are reproductive structures, usually adapted for dispersal and surviving for extended periods of time in unfavorable conditions. Fungal propagule also include conidia (also termed conidiospores or mitospores) which are asexual non-mobile spores.

Surfactant. As used herein, this term refers to agents capable of reducing surface tension between the pesticide and the liquid phase to which it is being admixed or between the pesticide solution and the plant surface. Surfactants may act as detergents, wetting agents, emulsifiers, foaming agents and/or disintegrants. Surfactants are usually amphophilic organic compounds.

Wettable powder: As used herein, the term “wettable powder” or WP is intended to refer to a formulation consisting of an active ingredient (e.g. a pesticide) in a finely ground state combined with different adjuvants (e.g., wetting agents, stabilizing agents) and bulking agents. The surfactants or disintegrants used facilitate the dispersion of wettable powders into water. Wettable powers are designed to be applied as a dilute (usually aqueous) suspension through liquid spraying equipment. As wettable powders are not mixed with water until immediately before use, storing and transporting the products is simplified as the weight and volume of the water is avoided. Wettable powders may be supplied in bulk or in measured sachets made from water soluble film to simplify premixing and reduce operator exposure to the product.

### Solid Pesticidal Composition

Traditionally, pesticides such as insecticides are formulated as either wettable powders or granules. The pesticidal composition described herein is a solid compacted formulation for pesticides, such as insecticides, it distinguishes from existing wettable powders and granules because it provides little to no dust (during storage, handling or dispersion in water). This reduction/elimination of dust increases the safety of the composition because it reduces the risk of inhalation of the insecticide by the end users. In some embodiments, the pesticidal composition is less bulky (in some embodiments three times less bulky) then comparable wettable powder formulations and is therefore more suited for packaging and transportation.

Further, because the pesticidal composition of the invention is compressed/compacted during its manufacture, it can be designed in any shape or form. For example, it can be compacted into a tablet (also referred to as a bar or a briquette) which can facilitate dispensing. In addition, because the pesticidal composition uses a water-dispersible agricultural carrier, in some embodiment, it can be easily dispersed in cold water without the use of surfactants. In some embodiments, the pesticidal composition can be stored for several months (in some embodiments up to 12 months) at room temperature without lost or reduction of pest-control efficacy.

In other embodiment, suspendibility (e.g., percentage of sediment weight to total weight) of the pesticidal composition can be 88-77% w/w. In another embodiment, the suspendibility is 72.3±11.2% (mean±95% Cl). In embodiments, wetting time (e.g., time required for completing wetting of the composition) is 22-28 sec. In an alternative embodiment, the wetting time is 25.7±8.0 sec (mean±95% Cl).

Further, as it will be shown below, the pesticidal composition can also be used in organic crop production. It can be designed to use only organic-acceptable components which will be specific for some target pests, will not harm beneficial insects (parasites and predators) of those targets pests, will not be phytotoxic and/or will not be harmful towards bees.

The solid pesticidal composition of the invention is obtained by submitting a mixture of dry components to a compaction process (hydraulic press or roll compaction, for example). The mixture comprises (or consists of) a microbial propagule and a water-dispersible agriculturally acceptable carrier and can include a surfactant and/or a disintegrant. The mixture optionally further comprises (or includes) a water dispersant, and/or a binder. The process for obtaining the solid pesticidal composition does not include (or lacks) the use of a granulating fluid to the dry mixture and/or a drying step of the granules prior to compaction. The process does not include (or lacks) a heating step for preparing the granules as currently required in a wet granulation process.

In a further embodiment the solid pesticidal composition of the invention is an effervescent solid formulation which can be produced the same way as the conventional solid formulation requiring humidity control to control the effervescent reaction and packaging restrictions.

The first component of the pesticidal composition is a pesticide, and in some embodiment, the pesticide is an insectide. As used herein, the term “pesticidal agent” refers to an agent capable of deterring, incapacitating, killing or otherwise discouraging plant pest, such as, for example, insects. The pesticidal composition described herein are especially advantageous for deterring, incapacitating, killing or otherwise discouraging phytophagous insects. Examples phytophageous insects include, but are not limited to, insects of the Isopoda order (e.g. Oniscus asellus, Armadium vulgare, Porcellio scaber), from the Diplopoda order (e.g. Blaniulus guttulatus), from the Chilopoda order (e.g. Geophilus carpophagus, Scutigera spp.), from the Symphyla order (e.g. Scutigerella immaculate), from the Thysanura order (e.g. Lepisma saccharina), from the Collembola order (e.g. Onychiurus armatus), from the Orthoptera order (e.g. latta orientalis, Periplaneta americana, Leucophaea maderae, Blattella germanica, Acheta damomesticus, Gryllotalpa spp., Locusta migratoria migratorioides, Melanoplus differentialis, Schisterocerca gregaria), from the Dermaptera order (e.g. Forficula auricularia), from the Isoptera order (e.g. Reculitermes spp), from the Anoplura order (e.g. Phylloxera vastatrix, Pemphigus spp., Pediculus humanus corporis, Haematopinus spp., Linognathus spp.), from the Mallophaga order (e.g. Trichodectes spp., Damalinea spp.), from the Thysanoptera order (e.g., Hercinothrips femoralis, Thrips tabaci), from the Heteroptera order (e.g. Eurygaster spp., Dysdercus intermedius, Piesma quadrata, Cimex lectularius, Rhodnius prolixus, Triatoma spp.), from the Homoptera order (e.g. Aleurodes brassicae, Bernisia tabaci, Trialeurodes vaporariorum, Aphis gossypii, Brevicoryne brassicae, Cryptomyzus ribis, Doralis fabae, Doralis pomi, Erisoma lanigerum, Hyalopterus aruadinis, Macrosiphum avenae, Myzus spp., Phorodon humuli, Rhopalosiphum padi, Empoasca spp., Scotinophora coarctata, Drasicha mangiferae, Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.), from the Heteroptera order (e.g. Lygus spp., Nezara viridula, Drasicha mangiferae, Euschistus spp.), from the Lepidoptera order (e.g. Pectinophora gossypiella, Bupalus piniarius, Chemimatobia brumata, Lithocolletis blancardella, Hyponomeuta padella, Plutella maculipennis, Malacosoma neustria, Euproctis chrysorrhoea, Lymantria spp., Diathrea sacharalis, Bucculactrix thurberiella, Phyllocnistis citrella, Agrotis spp., Euxoa spp., Feltia spp., Earias insulana, Heliothis spp., Laphygma exigua, Mamestra brassicae, Panolis flammea, Prodenia litura, Spodoptera spp., Trichoplusia ni, Carpocapsa pomonella, Ostrinia spp., Perileucoptera coffeella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Dendrolimus spp., Laspeyresia pomonella), from the Coleoptera order (e.g., Anobium punctatum, Hypothemenus hampei, Pityogenes chalcographus, Cyrlomon luridus, Xyleoterus lineatus, Ips typographus, Rhizopertha dominica, Bruchidius obtectus, Acenthoscelides obtectus, Hylotrupes bajulus, Agelastic alni, Leptinotarsa decemlineata, Phaeddn cochleariae, Diabrotica spp., Psylliodes chrysocephala, Epilachna varivestis, Atomaria spp., Oryzaephillus surinamensis, Anthonomus spp., Sitophilus spp., Otiorrhynchus sulcatus, Sitona lineatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololecus, Gibbium psylliodes, Tribolium spp., Brontispa longissima, Tenebrio molitor, Agriotes spp., Conoderus spp., Melolontha melolontha, Sphenophorus-Levis, Amphimallon solstitialis and Costelytra zealandica), from the Hymenoptera order (e.g. Diprion spp., Hoplocampa spp., Lasius spp., Monomorium pharaonis, Vespa spp.) from the Diptera order (e.g. Aedes spp., Anopheles spp., Culex spp., Drosophila spp., Musca spp., Fannia spp., Calliphora erythrocephala, Lucilla spp., Chrysomyia spp., Cuterebra spp., Gastrophilus spp., Hypobosca spp., Glossina moritans, Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa), from the Siphonaptera order (Xenopsylla cheopis, Ceratophyllus spp), from the Arachnida order (e.g. Scorpio maurus, Latrodectus mactans), from the Acarina order (e.g. Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp.). In an embodiment, the pesticide is specific for a single order, a single species or a single genus of insects. Alternatively the insecticide can have a broader toxicity spectrum and be entomopathogenic towards more than one order, more than one species or more than one genus of insects. In an embodiment, the insecticide of the pesticidal composition is specific for phytophageous insects and is harmless (e.g., fails to show toxicity) against predators or parasites of phytophageous insects and/or bees.

In another embodiment, the pesticide of the pesticidal composition preferably does not induce cytotoxic effects in the plant to which it is feeing applied. For example, in some embodiments, the pesticidal composition is not considered phytotoxic to plants of different families such as Solanaceae, Brassicaceae, Asteraceae, Poaceae and/or Fabaceae.

The pesticidal agent is provided in an agriculturally effective amount (dose) effective in mediating the reduction of pest density below a crop injury level and, in some embodiments, can lead to the eradication of the presence of a pest in a plant or crop. It is also to be understood herein that a “agriculturally effective amount” may be interpreted as an amount giving a desired agricultural effect, either applied in one dose or in any dosage, applied alone or in combination with other agents.

The pesticide of the pesticidal composition must be amenable to compression and retain its pesticidal activity once compressed into a solid form. Further, since the composition are obtained through a process performed in the absence of a granulating liquid or the application of heat, the pesticide of the composition can be heat and/or moisture sensitive. One of the pesticides that can be advantageously used in the pesticidal composition is a microbial propagule. Microbial propagules (such as bacterial and/or fungal propagules) have been shown to be efficient to control pest without exhibiting cytotoxic or phytotoxic effects against the plants to which they are being applied.

In one embodiment, the microbial propagule is a fungal propagule, for example, a propagule from an entomopathogenic fungus. One of the entomopathogenic fungus propagule that can be advantageously used in the pesticidal composition is the conidia of Beauveria bassiana (Balsamo) Vuillemin (Hypocreales). An advantage of using B. bassiana's over other entomopathogenic microorganisms is its ability to infect the insect through both ingestion and contact, thus making the eggs, larvae, pupae and adults as well as diapausing stages sensitive to B. bessiana-based fungal preparations. Upon contact with the insect's cuticle, the fungal infectious unit, the conidiospore, germinates and penetrates the tegument combining mechanical pressure and enzyme action on the cuticle. In the insect's tissues and hemolymph, the fungus produces hyphae, which invade the insect and provoke its death.

One strains of B. bassiana (strain ANT-03 or isolate CCFC 242052 of the Canadian Collection of Fungal Cultures) is highly pathogenous for its target pests. Such target pests include, but are not limited to, tarnished plant bugs (L. lineolaris), whiteflies (Aleyrodoidea), aphids (Homoptera: Aphididae), thrips (Thysanoptera), strawberry bud weevils (Anthonomus signatus (Say) (Coleoptera: Curculionidae)), and stripped cucumber beetles (Acalymma vittatum (Coleoptera: Chrysomelidae)). This B. bassiana strain is also considered non toxic to most predatory insects in the ecosystem (for example, Coleoptera: Coccinellida (Coleomegilla maculata lengi Timb.), Neuroptera: Chrysopidae (Chrysoperla rufilabris), Hemiptera: Pentatomidae (Perillus bioculatus (F.)), green lacewing, the twospotted stink bug). This B. bassiana strain is also considered non-toxic towards bees.

In an embodiment, if is possible to use a fungal propagule from a single species, a single genus or a single strain of entomopathogenic fungus. Alternatively, it is also possible to use a propagule from a combination of more than one species, more than one genus or more than one strain of entomopathogenic fungus. Exemplary entomopathogenic fungus include, but are not limited those from the Hypocreales of the Ascomycota order (e.g., Beauveria spp., Metarhizium spp., Nomuraea spp., Paecilomyces spp., Hirsutella spp., Cordyceps sp.) as well as Entomophthorales of the Zygomycota order (e.g., Entomophthora spp., Zoophthora spp., Pandora spp., Entomophaga spp.). Additional species from which a fungal propagule can be included in the pesticidial composition include, but are not limited to, Beauveria brongniartii, Metarhizium anisopliae (Metschn.), Metarhizium anisopliae var. acridium, Aschersonia aleyrodis, Sporothrix insectorum, Isaria fumosorosea, Lecanicillium spp., Verticillium spp., Tolypocladium spp., Paecilomyces spp., Nomuraea spp., Hisutella spp., Culcinomyces spp., Sorosporella spp., Fusarium spp., Trichoderma spp. and/or Exserohilum spp. In one embodiment, the fungal propagule comprises (or consists of) a conidia from a Beauvaria sp. In an alternative embodiment, the fungal progagule comprises (or consists of) a plurality of conidiae from different entomopathogenic fungi.

In still another embodiment, the microbial propagule is considered hydrophobic. As is known in the art, the hydrophobicity of a microbial propagule can vary from strain to strain and also depends from abiotic factors (such as pH, temperature, etc.). In some embodiment, the hydrophobicity of B. bassiana propagules can have an hydrophobicity ranging between about 60 to 80 percent based on the salt-mediated aggregation and sedimentation test (SAS).

In some embodiment, the weight percentage of the microbial propagule (with respect to the total weight of the pesticidal composition) is between 15 to 25%, 16 to 24%, 17 to 23%, 18 to 22% or 19 to 21%. In optional embodiments, the weight percentage of the microbial propagule (with respect to the total weight of the pesticidal composition) is about 20%.

The second component of the pesticidal composition also comprises an agriculturally acceptable carrier. As used herein, the term “agriculturally acceptable” carrier refers to an acceptable carrier that may be applied to a crop without inducing toxicity to the crop. The term also refers to its ability not to interfere (e.g., destroy), the biocidal activity of the pesticide. In the context of the present invention, the agriculturally acceptable carrier retains its agriculturally acceptable properties even when it is submitted to compaction and/or compression to form the solid pesticidal composition. Still in the context of this invention, the agriculturally acceptable carrier in its compressed/compacted form is dispersible in water (e.g. distribute into finer particles in water). In some embodiments, the agriculturally acceptable carrier can be used to facilitate the dispersion of the pesticide in a sprayable liquid.

In some embodiments of the pesticidal composition described herein, the agriculturally acceptable carrier is used not only to provide a pesticidal composition in a solid compacted form, but can also be used as an insect repeller. In this embodiment the resulting pesticidal composition provides a dual-mode of action where the microbial propagule limits the viability of the target pests (by, for example, colonizing and killing the target pests) and the agriculturally acceptable carrier repels targets pests from the crop.

In other (complementary or alternative) embodiments, the agriculturally acceptable carrier can protect the microbial propagule from harsh environmental conditions once it has been applied on crops.

In some embodiment, the weight percentage of the agriculturally acceptable carrier (with respect to the total weight of the pesticidal composition) is between 50 to 70%, 55 to 70%, 60 to 70%, 62 to 70% or 50 to 62%, 56 to 62%, 60 to 62%. In optional embodiments, the weight percentage of the carrier (with respect to the total weight of the pesticidal composition) is about 52%.

In one embodiment, the agriculturally acceptable carrier is cellulose that acts as an inert material and a binder facilitating dry compaction. Binders are normally necessary in effervescent solid formulations to bring their hardness to a point where handling is possible. The ideal amount of binder is one that makes the formulation herd enough to handle, but soft enough to disintegrate. The weight percentage of cellulose may be between 5% to 15%.

In an advantageous embodiment, a clay can be used as the agriculturally acceptable carrier. Clays are amenable of being mixed with the microbial propagule and submitted to dry compaction to form the solid pesticidal composition. In addition, some clays are also known to have insect-repelling properties. Further, some clays are also recognized as useful for protecting microbial propagules from harmful ultra-violet rays. The use of clays into organic crop production has also been recognized. Exemplary clays include, but are not limited to the kaolin clay, kaolinite, bentonite, montmorillonite and/or attapulgite. In the pesticidial composition. In an embodiment, a single clay is used. In an alternative embodiment, a combination of more than one clay is used.

The pesticidal composition can optionally comprise an additional water dispersant. Such dispersant can be used to facilitate the water dispersion of the pesticidal composition. As indicated above, the pesticidal compositions described herein are free of surfactants and/or disintegrate and as such, the additional water dispersant is not a surfactant or a disintegrate. Similar to the carrier, the water dispersant must also be agriculturally acceptable and amenable to compression/como paction. In some embodiment, the additional water dispersant can play a dual role of protecting the pesticide from harsh environmental conditions and thereby increase of prolong its biocidal activity as well as facilitating its dispersion in a sprayable liquid.

In some embodiments, the weight percentage of the additional water dispersant (with respect to the total weight of the pesticidal composition) is between 10 to 25%, 12 to 23%, 14 to 21%, 15 to 20% or 16 to 19%. In optional embodiments, the weight percentage of the additional water (with respect to the total weight of the pesticidal composition) is about 17%.

Exemplary water dispersant includes, but are not limited to starch such as a water-soluble starch. Some water soluble starch are known to facilitate water dispersion of hydrophobic components (such as for example hydrophobic microbial propagule) as well as to protect microbial propagule from harmful ultra-violet rays. Some water soluble starches are also used in organic crop production. Water-soluble starches include, but are not limited to, corn starch, rice starch, barley starch, wheat starch and/or potato starch. In an embodiment, a single starch (e.g., corn starch, rice starch, barley starch, wheat starch or potato starch) is used. In an alternative embodiment, a combination of more than one starch (e.g., corn starch, rice starch, barley starch, wheat starch and/or potato starch) is used.

In the effervescent embodiment of the present invention the water dispersant may include calcium carbonate (GaCO₃), in either a granulated or powder form, in combination with citric acid. Citric acid acts as a disintegration agent in combination with CaCO₃ by producing the effervescent effect. Effervescence is the reaction (in water) of acids and bases producing carbon dioxide. In the embodiment CaCO₃ releases the carbon dioxide producing effervescence or bubbling effect when the formulation comes in contact with water with the citric acid. The carbon dioxide causes the formulate disintegrations. Concentrations of the citric acid are preferrably greater than CaCO₃ in order to provide proper effervescence. CaCO₃ may also provide sun screening properties. The weight percentage of calcium carbonate may be between 5% to 15% and the weight percent of citric acid may be between 10% to 30% so that the ratio of citric acid to calcium carbonate is 2:1. The weight percent of starch may be between 3% to 10%.

The effervescent solid pesticidal composition allows for safer handling of the composition in comparison with a powder form and does not require bulky transportation. Furthermore it is easy to disperse in cold water due to the effervescence effect and is not phytotoxic. It has improved active ingredient efficacy due to sun screening effect from clay, calcium carbonate and starch, and has an improved shelf life of the active ingredient due to presence of kaolin clay as spore protectant and calcium carbonate as a desiccant.

The pesticidal composition can optionally comprise a binder or a sticking agent. Such binder or sticking agent can be used to increase the cohesion of the components of the pesticidal composition. Similar to the carrier, the binder or sticking agent must also be agriculturally acceptable and amenable to compression/compaction. Even though the use of a binder can delay the water dispersion of the carrier, it must not prevent the carrier from being dispersed in water (and optionally in cold water). The binder can also be selected to further protect or stabilize the insecticide by, for example. Increasing its rain fastness. Some binders used in organic crop production can also be incorporated in the pesticidal composition described herein.

In some embodiment, the weight percentage of the binder (with respect to the total weight of the pesticidal composition) is between 0.5 to 5%, 0.5 to 4%, 0.5 to 3%, 0.5 to 2%, 0.5 to 1% or between 1 to 5%, 1 to 4%, 1 to 3%, 1 to 2%. In optional embodiments, the weight percentage of the binder (with respect to the total weight of the pesticidal composition) is about 1%.

In one embodiment, the binder is a gum. Gums are known to be amenable to compaction, can provide binding in a dry composition, can be selected for organic crop production and some have been shown to increase the rain fastness of microbial propagule (such as fungal propagule). Exemplary gums include, but are not limited to xanthan gum. Emultex™ (a low viscosity natural gum), acacia gum, and/or sodium alginate and carrageenan. In an embodiment, a single binder or gum is used in the preparation of the pesticidal composition. In an alternative embodiment a combination of more than binder or gum is used in the preparation of the pesticidal composition.

The pesticidal composition can optionally comprise a surfactant. Such a surfactant can be used to decrease surface tension between the solid components of the pesticidal composition and aqueous solution. The surfactant must also be agriculturally acceptable and amenable to compression/compaction.

Tween™ is a detergent that provides surfactant properties to the composition, lowering surface tension between solids and liquid when the formulation is dispersed into a liquid solution. Another aspect of the surfactant is that it acts as a stabiliser of fungal conidia during storage. The weight percent of Tween™ may be between from 0.3% and 1%.

Polyethylene glycol (PEG) is a water-soluble molecule, which can be coupled to hydrophobic molecules to produce a non-ionic surfactant. PEG acts as a surfactant, reducing surface tension between solid components of the mixture and liquid when dispersed in aqueous solution. PEG can act not only a surfactant, but also as a water-soluble lubricant for the effervescent solid formulations, especially important during dry compaction process. Polyethylene glycol has a low toxicity and is used as a lubricating coating for various surfaces in aqueous and non-aqueous environments. The weight percent of Polyethylene glycol maybe between from 3% and 10%.

Depending on the intended, uses of the solid pesticidal composition, additional components can be added, such as, for example, a fertilizer, etc. These additional components are preferably amenable to compaction, agriculturally acceptable and can be used in organic crop production.

### Sprayable Liquid and Associated Uses

The solid pesticidal composition of the invention is not to be applied to a plant or a crop as a solid, it is preferably dispersed within a sprayable liquid which can be applied to the aerial parts of the plant and/or the roots. It is understood that the pesticidal composition cannot be solubilised into the sprayable liquid due to the hydrophobic nature of its main components. However, in the presence of a sprayable liquid, the components of the solid pesticidal composition are dispersed within the liquid.

In an embodiment, the solid pesticidal composition is optionally provided as a tablet or briquette with marks associated to a specific weight of the pesticidal composition. As such, the user can easily determined (without weighing the pesticidial composition) the amount of the pesticidal composition that should be dispersed into the sprayable liquid.

In one embodiment, the sprayable liquid is aqueous and the solid composition is mixed with the sprayable liquid to form an aqueous sprayable liquid. In some embodiments, the concentration of the pesticidal composition in the sprayable liquid is between about 1 to 6 g per L. In alternative or complementary embodiments, the concentration of the microbial propagules in the sprayable liquid is between about 1×10⁷ to 1×10⁹ propagules/ml or between about 1×10¹⁰ to 1×10¹² propagules/mL. The aqueous sprayable liquid can be water and even cold wafer (e.g., at a temperature between about 15° C. to about 24° C. or between about 15° C. to about 18° C.). This aqueous sprayable liquid can be advantageously applied to plants/crops growing in an environment having an ambient temperature of less than about 30° C. and a relative humidity higher than about 40%.

In an alternative embodiment, the sprayable liquid is an oil-in-water emulsion of the solid pesticidal composition. The oil-in-wafer emulsion is obtained by combining a mixture of an oil and a surfactant to an aqueous sprayable liquid having dispersed components of the pesticidal composition. The weight/weight concentration of the oil/surfactant mixture in the oil-in-water emulsion is between about 0.5 to 2%, and preferably 1%. The oil in the oil/surfactant mixture can be a mineral oil or vegetable oils (such as for example, a rapeseed oil, a corn oil, a sunflower oil) or a mixture of a vegetable and/or mineral oils. The weight concentration of the oil in the oil/surfactant mixture is between about 95 to 88%, and preferably 96%. The surfactant of the oil/surfactant mixture is a non-ionic surfactant and preferably results in an hydrophile-lipophile balance (HLB) of the resulting oil-in-water emulsion between 8 to 16, and even more preferably of 12. The surfactant of the oil/surfactant mixture can be a single surfactant (such as, for example, Twen-40™, Tween 60™, Tween 65™, Tween 80™, Span 20, Span 80 or Myrj 49, Brij 97, Merpol, Igepal, Hydroponix™ and PEG) or a combination of surfactants (such as, for example, a combination of Twen 40™, Tween 60™, Tween 65™, Tween 80™, Span 20, Span 80 or Myrj 49, Brij 97, Merpol, Igepal, Hydroponix™ and/or PEG). An advantageous combination of surfactants is a mixture of Tween 80 (at a weight concentration of between about 78 to 82%, preferably 80% of the total combination of surfactants) and Span 80 (at a weight concentration of between about 18 to 22%, preferably 20% of the total combination of surfactants). In combination or alternatively, the surfactant can be a lecithin, such as, for example, a soy lecithin. Alternatively, the surfactant can be Hydroponix™.

Once the solid pesticidal composition has been admixed with the sprayable liquid, it is applied to the aerial part(s) of the plant and/or roots for preventing/limiting pest. Because the solid pesticidial composition comprises a microbial propagule (and in a preferred embodiment, a fungal propagule), the sprayable liquid is preferably not applied simultaneously with fungicides.

### Process for Making the Pesticidal Composition

As indicated herein, the solid pesticidal composition is obtained through dry granulation or dry compaction. The solid pesticidal composition will disperse faster in water than other formulations (such as wettable powders or granules produced by wet compaction) due, in part, to the low-binding properties of the components used and inter-particle air removal during compaction. The any granulation or dry compaction process also limits viability diminishing of the microbial propagules by significantly reducing the manipulation of the components and avoiding the use of a granulating liquid and drying of the product. The dry granulation or dry compaction process is particularly advantageous with respect to the wet granulation process for formulating microbial propagules-containing pesticidal composition: it is more efficient (reduction in time, labor, material and equipment use), it is less detrimental to the viability of the microbial propagules and it is less costly. The dry granulation or dry compaction of components as proposed herein is advantageous because the components need not to be soluble in water to be admixed and the dry compaction process provides formulations which are more easily dispersed in water and more efficiently applied to plants.

In the process for producing the solid pesticidal composition, a substantially homogenous mixture of a microbial propagule and a water-dispersible agriculturally acceptable carrier is provided. As used herein, the term “substantially homogenous” refer to the property of the mixture of dispersing the microbial propagule within the water-dispersible agriculturally acceptable carrier, so that once it is compacted, the microbial propagule is present throughout the composition (and not concentrated in one section of the composition such as the surface or the core). The mixture can optionally comprise an additional wafer dispersant and/or a binder (also substantially homogenously dispersed within the carrier). The components of the mixture can be provided in a solid form (such as a powder) for facilitation the substantial homogeneity of the mixture.

In some embodiment to limit the degradation of the microbial propagule, the microbial propagules are first admixed with a binder. The microbial propagules/binder mixture is then admixed with a water dispersant. Further, the microbial propagules/binder/water dispersant mixture is admixed with the agriculturally acceptable carrier. The microbial propagules/binder/water dispersant/agriculturally acceptable carrier mixture is the submitted to dry compaction.

Once the initial mixture is provided, it is submitted to compaction. The compaction is provided in the absence of a granulating fluid. The compaction can be achieved through the use of a hydraulic press (compaction force between about 250 to about 500 kg) to remove the air from the composition and provide the solid formulation (such as a tablet). The compaction can also be achieved through the use of a roll compactor. In this embodiment, the initial mixture is passed through the transporter (roll compactor) to produce a solid formulation such as a tablet, briquette or individual granules depending on the intended use. Care should be taken during the compaction process to preserve the viability of the microbial propagules, for example, by providing a compaction force which does not substantially reduce the viability of the microbial propagules. As shown below, the use of an excessive compaction force can decrease the viability of the microbial propagules.

Care can also be taken during the storage of the compacted formulations to preserve the viability of the microbial propagules. For example, the solid formulation can also be packaged in water-impermeable packaging to prevent or limit loss in viability of the microbial granules.

The process for producing the solid pesticidal composition that is effervescent is similar to solid pesticidal composition in that it is a dry compaction using the Stokes D3 16 station tablet press or similar. Specifically the effervescent composition requires microbial propagules, clay, cellulose, starch, calcium carbonate, citric acid, surfactant and lubricant in the weight percentages previously set out. Due to the effervescent nature of the composition, the production requires strict control of the humidity levels so as not to initiate the effervescent reaction and reduce effectiveness of production bathes. Furthermore all the ingredients must be anhydrous and be packages in high moisture barrier containers such as foil bags or high density polyethylene bags. The hardness levels tested (Table 7); 4.3 kg, 6 kg, 15 kg and 16 kg All tested hardness levels except 4.3 kg reduced conidia germination up to 10-15% (Table 1A). The hardness level is a minimal force or mass (in kg) that applied to the compacted product and make it crush.

The present invention will be more readily understood by referring to the following examples which are given to illustrate the invention rather than to limit its scope.

### EXAMPLE I

### Process for Making Dry Compacted Microbial Propagules

Methodology. 20% (w/w) of dried B. bassiana spores were mixed by vortex with 82% (w/w) kaolin clay (Sigma Aldrich, Canada), 17% (w/w) of water soluble corn starch (Sigma Aldrich, Canada) and 1% (w/w) of xanthan gum (Sigma Aldrich, Canada). The components were compressed using a manual hydraulic press (Carver, USA) to produce individual briquettes. The following compression levels have been applied to the mixture of dry components: 0 (control). 250, 500, 750 and 1000 kg for 15 sec in a 9.5 mm matrix (generating a 1 or 2 g briquette). Resulted briquettes (5 briquettes for each compaction level) were used to test B. bassiana spore viability (48 h germination test). For the germination test, B. bassiana spores mixed with all mentioned above ingredients and not subjected to compaction were used as a control.

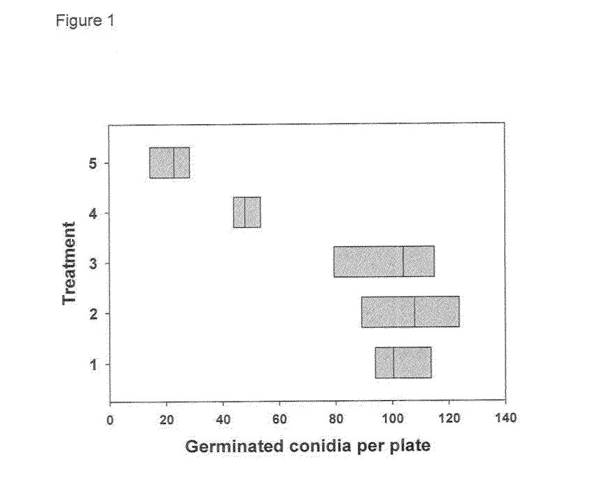

As shown in FIG. 1, dry compacted B. bassiana spores remain viable in briquettes which have been submitted to a compaction force of up to 500 kg. Further, no statistically significant difference between briquettes which have been submitted to a compaction force of between 250 to 500 kg has been observed. A significant reduction in B. bassiana viability has been observed in briquettes submitted to a compaction force of 750 or 1000 kg. However, the minimal compaction force required to produce a briquette was 250 kg (Table 1A).

TABLE 1A

| Treatment/Compaction | Germinated spores per plate | |
|---|---|---|
| force (kg) | (mean ± SE) | 95% CI |
| 0 (Control not | 102.8 ± 5.5 | 17.4 |
| compacted material) | | |
| 250 | 107.0 ± 9.0 | 28.5 |
| 500 | 99.5 ± 9.8 | 31.1 |
| 750 | 48.5 ± 2.6 | 8.4 |
| 1000 | 22.0 ± 3.7 | 11.9 |

SE = standard error;
95% CI = 95% confidential interval

### EXAMPLE II

### Use of Compacted Pesticide Formulation on Green House-Grown Tomatoes

Three protocols were conducted in greenhouse-grown tomatoes. A two-block design, with randomly selected and marked plants (six per replication) per treatment, was used in all greenhouse experiments. Bio-Ceres-WB (water dispersible briquettes) formulations of B. bassiana (strain ANT-03) were produced as indicated in Example I using XX compaction force. Experiments were conducted in the McGill University Horticultural Research Center (Ste-Anne-de-Bellevue, Quebec, Canada). The positive control (BotaniGard 22WP) was applied at the recommended rate as indicated below.

Various treatments were applied to greenhouse-grown tomatoes (Cultivar: Trust). The presence of whiteflies larvae (Trialeurodes vaporariorum) in the treated plants was then assessed. The plant stage was also determined using the following classification:
16 106, 6 leaf on main shoot unfolded.
61 601, first inflorescence: first flower open.
71 701, first fruit cluster: first fruit has reached typical size.
73 703, 3^{rd} fruit cluster: first and second fruits have reached typical size.
84 804, 40% of fruits show typical fully ripe color.

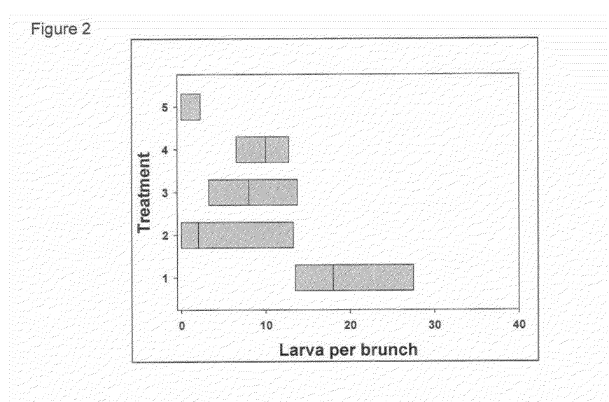

In Experiment 1, the following treatments were applied: 1/control (water); 2/BotaniGard 22™ WP diluted 1.25 g/L in wafer (4×10¹⁰ spores/L); 3/ BioCeres-WB diluted 1 g/L in water (1×10¹⁰ spores/L; 4/ BioCeres-WB diluted 2 g/L in water (2×10¹⁰ spores/L) or 5/ BioCeres-WB diluted 4 g/L in water (4×10¹⁰ spores/L). The results of experiment 1 are shown in Table 1 as well as on FIG. 2.

TABLE 1
Effect of various treatments (TRT) on whitefly (WF) larvae density
on greenhouse grown tomatoes (Experiment 1).

| | | | | | | WF | |
|---|---|---|---|---|---|---|---|
| | | | | Mean WF | | reduction (%) | |
| | | Product | | per plant | | to control | |
| | Volum. | rate | | low | mid | low | mid |
| TRT | (L/ha) | (g/ha) | Plant Stage | level | level | level | level |
| 1 | 1000 | 0 | 16.106 | 4.2a | 17.3a | — | — |
| 2 | 1000 | 1250 | 16.106 | 5.7a | 20.3a | — | — |
| 3 | 1000 | 1000 | 16.106 | 13.5a | 21.8a | — | — |
| 4 | 1000 | 2000 | 16.106 | 7.8a | 10.8a | — | 37.6 |
| 5 | 1000 | 4000 | 16.106 | 3.0a | 4.8a | 26.8 | 72.2 |
| 1 | 1550 | 0 | 61.601 | 11.2a | 14.3a | — | — |
| 2 | 1550 | 1937.5 | 61.601 | 4.2ab | 9.5ab | 62.5 | 33.6 |
| 3 | 1550 | 1550 | 61.601 | 3.3ab | 9.2ab | 70.5 | 35.7 |
| 4 | 1550 | 3100 | 61.601 | 5.2ab | 10.7ab | 53.6 | 25.2 |
| 5 | 1550 | 6200 | 61.601 | 1.2b | 3.0b | 89.3 | 79.0 |
| 1 | 1550 | 0 | 71.701 | 10.3a | 20.3a | * | * |
| 2 | 1550 | 1937.5 | 71.701 | 10.0a | 6.2ab | 3.0 | 69.5 |
| | | 1.94 | | | | | |
| 3 | 1550 | 1550 | 71.701 | 10.2a | 8.3ab | 0.9 | 59.1 |
| 4 | 1550 | 3100 | 71.701 | 8.5ab | 10.2ab | 17.5 | 49.8 |
| 5 | 1550 | 6200 | 71.701 | 0.3b | 1.5b | 97.1 | 92.6 |
| 1 | 2000 | 0 | 73.703 | 5.2a | 19.8a | * | * |
| 2 | 2000 | 2500 | 73.703 | 3.3a | 5.5c | 40.0 | 72.2 |
| 3 | 2000 | 2500 | 73.703 | 2.2a | 4.8c | 60.0 | 75.8 |
| 4 | 2000 | 4000 | 73.703 | 5.0a | 14.3c | 4.0 | 27.8 |
| 5 | 2000 | 8000 | 73.703 | 1.7a | 2.2c | 67.0 | 88.9 |
| 1 | 2000 | 0 | 84.804 | 4.0a | 11.5a | * | * |
| 2 | 2000 | 2500 | 84.804 | 3.5a | 8.3a | 13.0 | 28.0 |
| 3 | 2000 | 2000 | 84.804 | 2.3a | 5.8a | 43.0 | 50.0 |
| 4 | 2000 | 4000 | 84.804 | 3.0a | 8.0a | 25.0 | 30.0 |
| 5 | 2000 | 8000 | 84.804 | 2.2a | 1.8a | 45.0 | 84.0 |

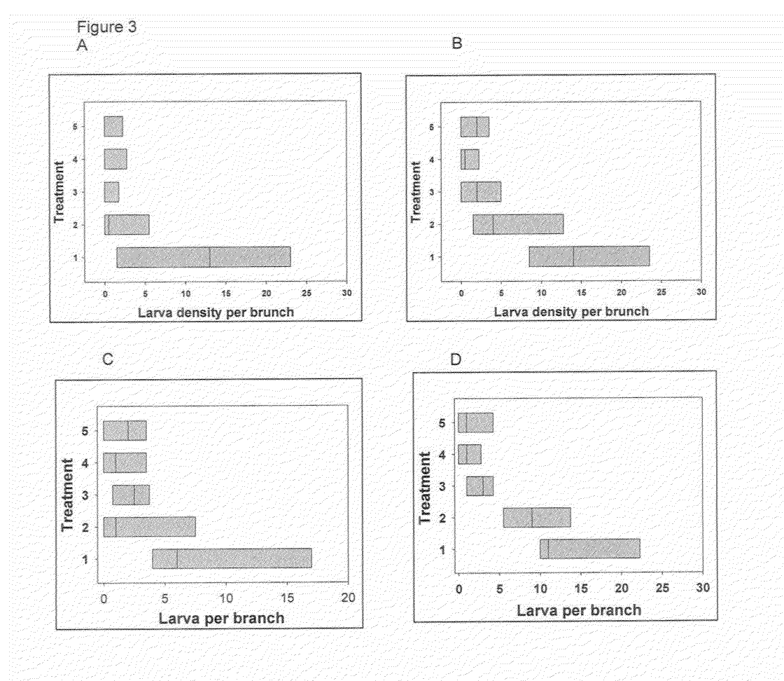

In Experiment 2, the following treatments were applied: 1/control (water); 2/BotaniGard 22™ WP diluted 1.25 g/L in wafer (4×10¹⁰ spores/L); 3/ BioCeres-WB diluted 4 g/L in water (4×10¹⁰ spores/L); 4/ BioCeres-WB diluted 6 g/L in water (6×10¹⁰ spores/L) or 5/ BioCeres-WB diluted 8 g/L in wafer (3×10¹⁰ spores/L). The results of experiment 2 are shown in Table 2 as well as in FIG. 3.

TABLE 2
Effect of various treatments (TRT) on whitefly (WF) larvae density on
greenhouse grown tomatoes (Experiment 2).

| | | | | | | WF | |
|---|---|---|---|---|---|---|---|
| | | | | Mean WF | | reduction (%) | |
| | Product | | | per plant | | to control | |
| | rate | Volume | | low | mid | Low | mid |
| TRT | (g/ha) | (L/ha) | Plant Stage | level | level | level | level |
| 1 | 0 | 1000 | 16.106 | 0.8a | 15.3a | — | — |
| 2 | 1250 | 1000 | 16.106 | 4.0a | 3.8bc | — | 75.2 |
| 3 | 4000 | 1000 | 16.106 | 2.2a | 1.7c | — | 88.9 |
| 4 | 6000 | 1000 | 16.106 | 0.4a | 2.2bc | 50.0 | 85.7 |
| 5 | 8000 | 1000 | 16.106 | 1.0a | 5.0b | — | 67.3 |
| 1 | 0 | 1550 | 61.601 | 12.7a | 15.7a | — | — |
| 2 | 1937.5 | 1550 | 61.601 | 2.2a | 6.8b | 82.7 | 56.7 |
| 3 | 6200 | 1550 | 61.601 | 0.8a | 2.7b | 93.7 | 82.8 |
| 4 | 9300 | 1550 | 61.601 | 1.5a | 1.0b | 88.2 | 93.6 |
| 5 | 12400 | 1550 | 61.601 | 0.8a | 2.0b | 93.7 | 87.3 |
| 1 | 0 | 1550 | 71.701 | 8.7a | 14.5a | — | — |
| 2 | 1937.5 | 1550 | 71.701 | 4.0ab | 9.2b | 54.0 | 36.6 |
| 3 | 6200 | 1550 | 71.701 | 2.5ab | 2.8c | 71.3 | 61.4 |
| 4 | 9300 | 1550 | 71.701 | 1.7b | 1.5c | 80.5 | 89.7 |
| 5 | 12400 | 1550 | 71.701 | 2.0b | 1.8c | 79.3 | 87.6 |
| 1 | 0 | 2000 | 73.703 | 6.2a | 6.7a | — | — |
| 2 | 2500 | 2000 | 73.703 | 0.7b | 2.8a | 88.7 | 58.2 |
| 3 | 8000 | 2000 | 73.703 | 0.3b | 1.5a | 95.2 | 77.6 |
| 4 | 12000 | 2000 | 73.703 | 0.5b | 0.8a | 91.9 | 88.1 |
| 5 | 16000 | 2000 | 73.703 | 1.5ab | 1.7a | 75.8 | 74.6 |
| 1 | 0 | 2000 | 84.804 | 1.5a | 9.7a | — | — |
| 2 | 2500 | 2000 | 84.804 | 0.3a | 4.2b | 80.0 | 56.7 |
| 3 | 8000 | 2000 | 84.804 | 0a | 2.2b | 100.0 | 77.3 |
| 4 | 12000 | 2000 | 84.804 | 0.3a | 2.2b | 80.0 | 77.3 |
| 5 | 16000 | 2000 | 84.804 | 1.0a | 2.0b | 33.3 | 79.3 |

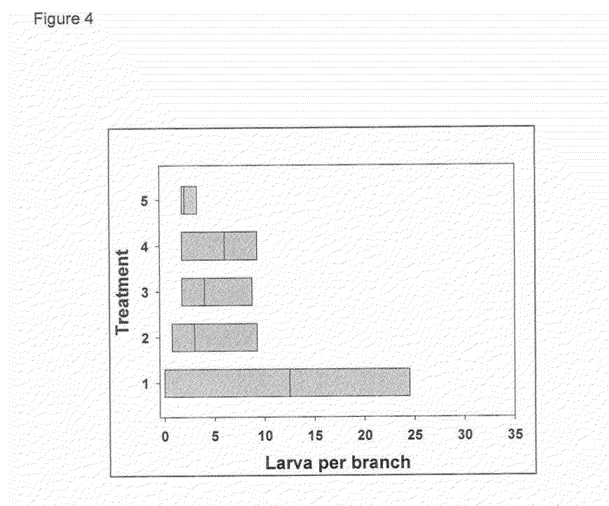

In experiment 3, the following treatments were applied: 1/control (water); 2/BotaniGard 22™ WP diluted 1.25 g/L in water (4×10¹⁰ spores/L); 3/ BioCeres-WB diluted 2 g/L in water (2×10¹⁰ spores/L); 4/ BioCeres-WB diluted 4 g/L in wafer (4×10¹⁰ spores/L) or 5/ BioCeres-WB diluted 6 g/L in water (6×10¹⁰ spores/L). The results of experiment 3 are shown in Table 3 as well as in FIG. 4.

TABLE 3
Effect of various treatments (TRT) on whitefly (WF) larvae density on
greenhouse grown tomatoes (Experiment 3).

| | | | | | | WF | |
|---|---|---|---|---|---|---|---|
| | | | | Mean WF | | reduction (%) | |
| | Product | | | per plant | | to control | |
| | rate | Volume | | low | mid | Low | mid |
| TRT | (g/ha) | (L/ha) | Plant Stage | level | level | level | level |
| 1 | 0 | 1000 | 16.106 | 3.5a | 6.7a | — | — |
| 2 | 1250 | 1000 | 16.106 | 4.5a | 10.0a | — | — |
| 3 | 2000 | 1000 | 16.106 | 3.5a | 8.7a | 0.0 | — |
| 4 | 4000 | 1000 | 16.106 | 2.8a | 6.8a | 20.0 | — |
| 5 | 6000 | 1000 | 16.106 | 2.2a | 5.7a | 28.6 | 14.8 |
| 1 | 0 | 1550 | 61.601 | 9.8a | 7.7a | — | — |
| 2 | 1937.5 | 1550 | 61.601 | 6.5ab | 5.7a | 33.7 | 26.0 |
| 3 | 3100 | 1550 | 61.601 | 1.2b | 4.0a | 87.8 | 48.1 |
| 4 | 6200 | 1550 | 61.601 | 2.5ab | 4.0a | 74.5 | 48.1 |
| 5 | 9300 | 1550 | 61.601 | 2.5ab | 3.2a | 74.5 | 58.4 |
| 1 | 0 | 1550 | 71.701 | 12.3a | 12.8a | — | — |
| 2 | 1937.5 | 1550 | 71.701 | 4.7a | 5.0a | 61.8 | 60.9 |
| 3 | 3100 | 1550 | 71.701 | 4.3a | 5.0a | 65.0 | 60.9 |
| 4 | 6200 | 1550 | 71.701 | 4.8a | 6.0a | 58.6 | 53.1 |
| 5 | 9300 | 1550 | 71.701 | 2.2a | 2.7a | 82.1 | 78.9 |
| 1 | 0 | 2000 | 73.703 | 2.3a | 8.0a | — | — |
| 2 | 2500 | 2000 | 73.703 | 2.5a | 6.2a | — | 22.5 |
| 3 | 4000 | 2000 | 73.703 | 2.5a | 3.8a | — | 52.5 |
| 4 | 8000 | 2000 | 73.703 | 3.8a | 3.3a | — | 58.8 |
| 5 | 1200 | 2000 | 73.703 | 2.0a | 4.3a | 13.0 | 42.2 |
| 1 | 0 | 2000 | 84.804 | 4.5a | 14.7a | — | — |
| 2 | 2500 | 2000 | 84.804 | 3.2a | 6.8ab | 29.0 | 53.7 |
| 3 | 4000 | 2000 | 84.804 | 2.3a | 4.2b | 49.0 | 71.4 |
| 4 | 8000 | 2000 | 84.804 | 3.2a | 2.8b | 29.0 | 81.0 |
| 5 | 1200 | 2000 | 84.804 | 1.3a | 3.7b | 71.1 | 74.8 |

The results provided in Experiment 1 indicate that BioCeres-WB applications at 4×10¹⁰ spores/L significantly decreased whitefly larva density, since it decreased the whitefly population by more than 90% when compared to the negative control (Table 1). Such treatment was also superior to BotaniGard™ treatment (Table 1). As shown in FIG. 2, the box plot analysis also showed that that all BioCeres-WB treatment caused a significant whitefly reduction in comparison with untreated control.

In Experiment 2, BioCeres-WB treatment caused a significant reduction in whitefly density (middle plant section) and was comparable or superior to BotaniGard™ treatment (Table 2). As shown in FIG. 3, in BioCeres-WB treated-plats, more than 50% of observed tomato plants had less than 5 whitefly larva per plant while in negative control treatment, more than 50% of plants has 10-15 larva per plant (low section) and up to 20-25 larvae/plant (middle section).

In Experiment 3, BioCeres-WB treatments reduced whitefly density in comparison with untreated control (FIG. 4). However, statistically significant reduction of white fly density by all BioCeres-WB treatments was shown after a 5^{th} application (Table 3).

Further BioCeresWB applied at different concentrations (1, 2, 4, 6 and 8 g/L) did not cause any phytotoxcity to tomato plants during different phenological stages: flowering, development and ripening of fruit (visual observations).

### EXAMPLE III

### Use of Compacted Pesticide Formulation on GreenHouse-Grown Cucumbers

Three protocols were conducted in greenhouse-grown cucumbers. A two-block design, with randomly selected and marked plants (six per replication) per treatment, was used in all greenhouse experiments. BioCeres-WB (wafer dispersible briquettes) formulations of B. bassiana (strain ANT-03) were produced as indicated in Example I using 300 kg compaction force. Experiments were conducted in the McGill University Horticultural Research Center (Ste-Anne-de-Bellevue, Quebec, Canada). The positive control (BotaniGard™ 22WP) was applied at the recommended rate as indicated below.

Various treatments were applied to greenhouse-grown cucumbers (Cultivar: Dishon) in which side shoots were removed during the vegetative period. The presence of thrips (Frankliniella spp.) on the leaves of the treated plants was then assessed. The plant stage was also determined according to the following classification:
16 106, six true leaf on main stem unfolded,
51.501, first flower initial with elongated ovary visible on main stem.
63.603, 3^{rd} flower open on main stem.
72 702. 2^{nd} fruit has reached typical size and form.
73 703, 3^{rd} fruit has reached typical size and form,
75 70 5, 5^{th} fruit has reaped typical size and form.

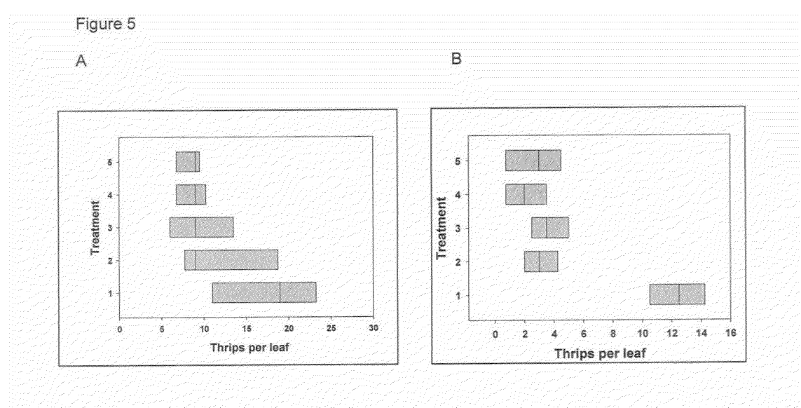

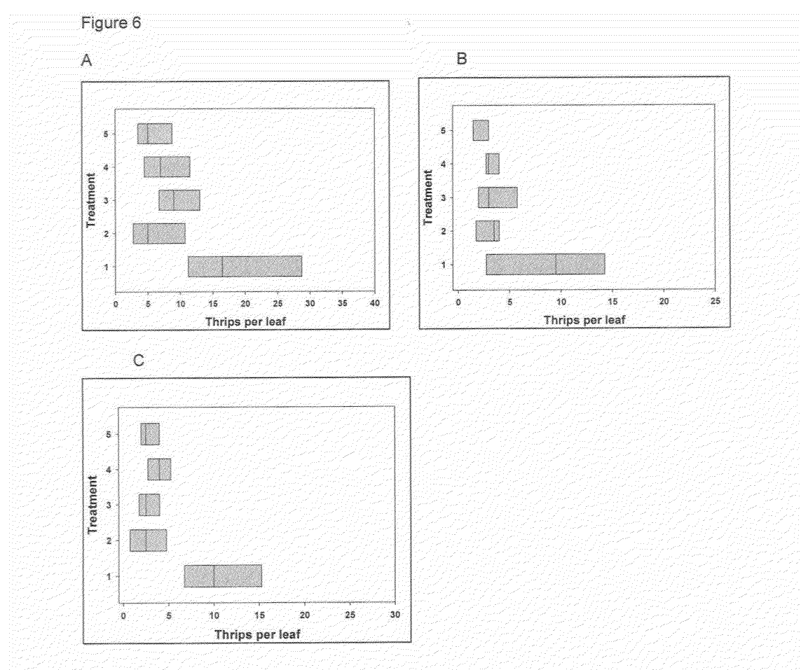

In Experiment 1, the following treatments were applied: 1 /control (water); 2/BotaniGard 22™ WP diluted 1.25 g/L in water (4×10¹⁰ spores/L); 3/ BioCeres-WB diluted 1 g/L in water (1×10¹⁰ spores/L; 4/ BioCeres-WB diluted 2 g/L in water (2×10¹⁰ spores/L) or 5/ BioCeres-WB diluted 4 g/L in water (4×10¹⁰ spores/L). The results of experiment 1 are shown in Table 4 as well as in FIG. 5.

TABLE 4
Effect of various treatments (TRT) on thrips leaf density on greenhouse grown
cucumbers (Experiment 1).

| | Product | Volume | Plant | Mean number of thrips per leaf | | | | | | |
|---|---|---|---|---|---|---|---|---|---|---|
| TRT | rate (g/ha) | (L/ha) | Stage | 4 | 6 | 8 | 10 | 12 | 14 | 16 |
| 1 | 0 | 1000 | 16.106 | 10.8a | 4.7a | 4.3a | * | * | * | * |
| 2 | 1250 | 1000 | 16.106 | 10.7a | 7.8a | 4.5a | * | * | * | * |
| 3 | 1000 | 1000 | 16.106 | 13.2a | 9.2a | 4.8a | * | * | * | * |
| 4 | 2000 | 1000 | 16.106 | 13.0a | 7.0a | 4.2a | * | * | * | * |
| 5 | 4000 | 1000 | 16.106 | 20.2a | 8.7a | 5.3a | * | * | * | * |
| 1 | 0 | 1550 | 51.501 | 12a | 12.7a | 10.7a | 7.5a | * | * | * |
| 2 | 1937.5 | 1550 | 51.501 | 12a | 12.7a | 6.8bc | 7.2a | * | * | * |
| 3 | 1550 | 1550 | 51.501 | 7.2ab | 9.3b | 7.7b | 4.7a | * | * | * |
| 4 | 3100 | 1550 | 51.501 | 4.5b | 9.3b | 5.0c | 6.7a | * | * | * |
| 5 | 6200 | 1550 | 51.501 | 4.8b | 9.8ab | 7.8b | 5.3a | * | * | * |
| 1 | 0 | 1550 | 63.603 | * | 10.5a | 17.8a | 11.8a | 9.0a | * | * |
| 2 | 1937.5 | 1550 | 63.603 | * | 12.5a | 12.0ab | 8.5a | 8.2a | * | * |
| 3 | 1550 | 1550 | 63.603 | * | 13.8a | 9.3b | 9.3a | 4.5a | * | * |
| 4 | 3100 | 1550 | 63.603 | * | 10.0a | 8.7b | 7.3a | 6.5a | * | * |
| 5 | 6200 | 1550 | 63.603 | * | 13.2a | 8.5ab | 9.3a | 6.5a | * | * |
| 1 | 0 | 1550 | 72.702 | * | 2.8a | 7.0ab | 10.5a | 7.0a | 7.7a | * |
| 2 | 1937.5 | 1550 | 72.702 | * | 6.5a | 8.0a | 7.8ab | 5.8a | 4.0b | * |
| 3 | 1550 | 1550 | 72.702 | * | 4.5a | 4.0c | 6.7b | 5.8a | 4.0b | * |
| 4 | 3100 | 1550 | 72.702 | * | 6.2a | 4.7bc | 6.5ab | 6.3a | 7.7a | * |
| 5 | 6200 | 1550 | 72.702 | * | 4.2a | 4.8abc | 7.5ab | 5.2a | 5.5ab | * |
| 1 | 0 | 2000 | 73.703 | * | * | 5.3a | 6.5a | 4.7ab | 5.3a | 4.3a |
| 2 | 2500 | 2000 | 73.703 | * | * | 4.0a | 3.8a | 5.5a | 3.2ab | 3.7a |
| 3 | 2000 | 2000 | 73.703 | * | * | 2.8a | 2.3a | 2.2b | 2.5b | 2.3a |
| 4 | 4000 | 2000 | 73.703 | * | * | 4.8a | 3.2a | 3.8ab | 2.2b | 2.5a |
| 5 | 8000 | 2000 | 73.703 | * | * | 3.0a | 2.3a | 3.7ab | 2.7b | 3.3a |
| 1 | 0 | 2000 | 75.705 | * | 2.7a | 18.5a | 12.3a | 10.5a | 10.7a | 6.3a |
| 2 | 2500 | 2000 | 75.705 | * | 0.8b | 3.3b | 3.2b | 4.5abc | 3.8b | 3.8b |
| 3 | 2000 | 2000 | 75.705 | * | 0.8b | 2.5b | 3.5b | 3.2bc | 2.8b | 2.2b |
| 4 | 4000 | 2000 | 75.705 | * | 1.5b | 1.3b | 2.2b | 1.8c | 3.2b | 3.3ab |
| 5 | 8000 | 2000 | 75.705 | * | 1.3b | 0.8b | 2.8b | 6.5ab | 4.0b | 4.2b |

In Experiment 2, the following treatments were applied: 1/control (water); 2/BotaniGard 22™ WP diluted 1.25 g/L in water (4×10¹⁰ spores/L); 3/ BioCeres-WB diluted 4 g/L in water (4×10¹⁰ spores/L); 4/ BioCeres-WB diluted 6 g/L in water (6×10¹⁰ spores/L) or 5/ BioCeres-WB diluted 8 g/L in water (8×10¹⁰ spores/L). The results of experiment 2 are shown in Table 5 as well as on FIG. 6.

TABLE 5
Effect of various treatments (TRT) on thrips leaf density on greenhouse grown
cucumbers (Experiment 2).

| | Product | | | | | | | | | |
|---|---|---|---|---|---|---|---|---|---|---|
| | Rate | Vol. | Plant | Mean number of thrips per leaf | | | | | | |
| TRT | (g/ha) | (L/ha) | Stage | 4 | 6 | 8 | 10 | 12 | 14 | 16 |
| 1 | 0 | 1000 | 16.106 | 12.8a | 14.3a | 6.7a | * | * | * | * |
| 2 | 1250 | 1000 | 16.106 | 9.0a | 7.7a | 3.7a | * | * | * | * |
| 3 | 4000 | 1000 | 16.106 | 6.7a | 5.0a | 2.2a | * | * | * | * |
| 4 | 6000 | 1000 | 16.106 | 4.8a | 5.7a | 4.2a | * | * | * | * |
| 5 | 8000 | 1000 | 16.106 | 7.8a | 4.5a | 2.7a | * | * | * | * |
| 1 | 0 | 1550 | 51.501 | 9.7a | 10.5a | 11.3a | 8.5a | * | * | * |
| 2 | 1937.5 | 1550 | 51.501 | 6.3a | 5.0a | 7.3ab | 6.2ab | * | * | * |
| 3 | 6200 | 1550 | 51.501 | 7.2a | 7.0a | 5.0ab | 6.3ab | * | * | * |
| 4 | 9300 | 1550 | 51.501 | 6.8a | 7.3a | 2.7b | 5.2ab | * | * | * |
| 5 | 12400 | 1550 | 51.501 | 6.3a | 6.5a | 5.7ab | 4.5b | * | * | * |
| 1 | 0 | 1550 | 63.603 | * | 16.3a | 13.5a | 19.2a | 12.3a | * | * |
| 2 | 1937.5 | 1550 | 63.603 | * | 12.0a | 4.3b | 6.7b | 5.0b | * | * |
| 3 | 6200 | 1550 | 63.603 | * | 8.7a | 9.7ab | 9.8b | 4.5b | * | * |
| 4 | 9300 | 1550 | 63.603 | * | 8.0a | 9.7ab | 8.0b | 9.0a | * | * |
| 5 | 12400 | 1550 | 63.603 | * | 8.2a | 8.0ab | 5.8b | 3.7b | * | * |
| 1 | 0 | 1550 | 72.702 | * | 6.5a | 10.5a | 12.0a | 13.3a | 7.7a | * |
| 2 | 1937.5 | 1550 | 72.702 | * | 4.2a | 3.3b | 5.7b | 3.0b | 2.5bc | * |
| 3 | 6200 | 1550 | 72.702 | * | 4.7a | 5.0b | 6.2b | 5.2ab | 1.5c | * |
| 4 | 9300 | 1550 | 72.702 | * | 4.7a | 4.5b | 6.0b | 11.7a | 6.2a | * |
| 5 | 12400 | 1550 | 72.702 | * | 4.7a | 4.8b | 5.0b | 6.5ab | 4.5ab | * |
| 1 | 0 | 2000 | 73.703 | * | * | 6.2a | 19.0a | 9.5a | 7.7a | 9.3a |
| 2 | 2500 | 2000 | 73.703 | * | * | 2.5a | 3.0b | 3.0b | 2.7bc | 3.3b |
| 3 | 8000 | 2000 | 73.703 | * | * | 2.5a | 4.5b | 4.2ab | 2.2bc | 1.7b |
| 4 | 12000 | 2000 | 73.703 | * | * | 3.3a | 1.2b | 3.2b | 3.3b | 3.5b |
| 5 | 16000 | 2000 | 73.703 | * | * | 1.3a | 1.7b | 2.3b | 1.0c | 2.7b |
| 1 | 0 | 2000 | 75.705 | * | 3.7a | 5.5a | 10.2a | 11.7a | 10.0a | 12.3a |
| 2 | 2500 | 2000 | 75.705 | * | 1.3b | 3.3b | 3.2b | 2.8b | 5.3ab | 4.7b |
| 3 | 6000 | 2000 | 75.705 | * | 1.8b | 4.5ab | 1.8b | 2.7b | 2.8bc | 3.2bc |
| 4 | 12000 | 2000 | 75.705 | * | 1.0b | 1.8c | 1.7b | 4.3b | 2.8bc | 5.2b |
| 5 | 16000 | 2000 | 75.705 | * | 1.0b | 1.7c | 1.8b | 3.2b | 1.7c | 2.3c |

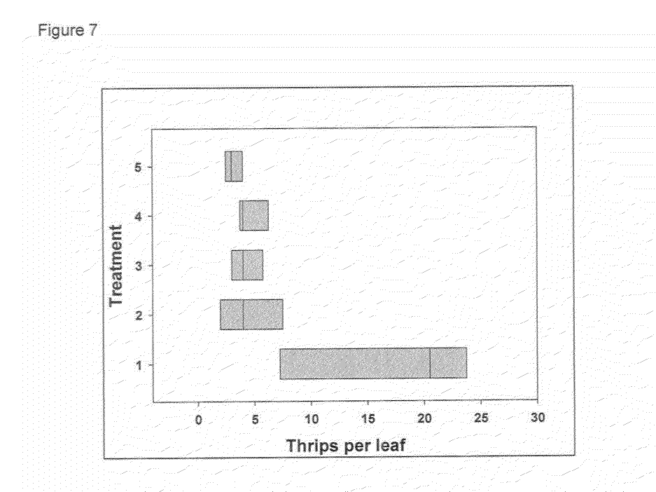

In Experiment 3, the following treatments were applied: 1/control (water); 2/BotaniGard 22™ WP diluted 125 g/L in water (4×10¹⁰ spores/L); 3/ BioCeres-WB diluted 2 g/L in water (2×10¹⁰ spores/L); 4/ BioCeres-WB diluted 4 g/L in water (4×10¹⁰ spores/L) or 5/ BioCeres-WB diluted 6 g/L in water (6×10¹⁰ spores/L). The results of experiment 3 are shown in Table 6 as well as on FIG. 7.

TABLE 6
Effect of various treatments (TRT) on thrips leaf density on greenhouse grown
cucumbers (Experiment 3).

| | Product | | | | | | | | | |
|---|---|---|---|---|---|---|---|---|---|---|
| | Rate | Vol. | Plant | Mean number of thrips per leaf | | | | | | |
| TRT | (g/ha) | (L/ha) | Stage | 4 | 6 | 8 | 10 | 12 | 14 | 16 |
| 1 | 0 | 1000 | 16.106 | 17.8a | 9.8a | 6.5a | * | * | * | * |
| 2 | 1250 | 1000 | 16.106 | 12.8a | 8.2a | 6.3a | * | * | * | * |
| 3 | 2000 | 1000 | 16.106 | 13.7a | 15.8a | 7.5a | * | * | * | * |
| 4 | 4000 | 1000 | 16.106 | 17.5a | 13.0a | 7.7a | * | * | * | * |
| 5 | 6000 | 1000 | 16.106 | 7.0a | 7.8a | 3.2a | * | * | * | * |
| 1 | 0 | 1550 | 51.501 | 25.5a | 16.8a | 13.7a | 8.3a | * | * | * |
| 2 | 1937.5 | 1550 | 51.501 | 16.3a | 11.8a | 8.7a | 5.2a | * | * | * |
| 3 | 3100 | 1550 | 51.501 | 16.2a | 10.2a | 6.8a | 4.2a | * | * | * |
| 4 | 6200 | 1550 | 51.501 | 17.2a | 13.5a | 10.2a | 6.2a | * | * | * |
| 5 | 9300 | 1550 | 51.501 | 9.3a | 10.2a | 7.8a | 5.8a | * | * | * |
| 1 | 0 | 1550 | 63.603 | * | 17.3a | 13.3a | 11.7a | 7.5a | * | * |
| 2 | 1937.5 | 1550 | 63.603 | * | 12.0a | 9.5a | 12.7a | 7.5a | * | * |
| 3 | 3100 | 1550 | 63.603 | * | 9.7a | 9.2a | 5.7a | 5.2a | * | * |
| 4 | 6200 | 1550 | 63.603 | * | 11.8a | 13.0a | 10.5a | 6.7a | * | * |
| 5 | 9300 | 1550 | 63.603 | * | 9.5a | 10.7a | 10.7a | 7.5a | * | * |
| 1 | 0 | 1550 | 72.702 | * | 6.7a | 6.0a | 8.5a | 7.5a | 5.2a | * |
| 2 | 1937.5 | 1550 | 72.702 | * | 6.2a | 6.0a | 5.5a | 6.5a | 3.7ab | * |
| 3 | 3100 | 1550 | 72.702 | * | 3.0a | 5.2a | 4.0a | 5.8a | 2.7b | * |
| 4 | 6200 | 1550 | 72.702 | * | 2.8a | 4.8a | 4.0a | 4.8a | 4.2ab | * |
| 5 | 9300 | 1550 | 72.702 | * | 2.8a | 3.5a | 2.5a | 4.0a | 4.2ab | * |
| 1 | 0 | 2000 | 73.703 | * | * | 3.5a | 4.0a | 4.7a | 4.5a | 6.8a |
| 2 | 2500 | 2000 | 73.703 | * | * | 3.0a | 3.0a | 1.8b | 1.5a | 2.8a |
| 3 | 4000 | 2000 | 73.703 | * | * | 1.7a | 2.5a | 3.2ab | 2.5a | 3.5a |
| 4 | 8000 | 2000 | 73.703 | * | * | 2.3a | 2.2a | 3.2ab | 2.2a | 2.7a |
| 5 | 12000 | 2000 | 73.703 | * | * | 1.0a | 1.7a | 2.3ab | 2.2a | 2.5a |
| 1 | 0 | 2000 | 75.705 | * | 6.5a | 5.7a | 8.5a | 6.3a | 6a | 16.8a |
| 2 | 2500 | 2000 | 75.705 | * | 1.7b | 3.0ab | 3.2b | 3.7bc | 4.7a | 5.0ab |
| 3 | 4000 | 2000 | 75.705 | * | 2.2b | 1.0b | 2.8b | 2.3c | 4.2a | 4.5ab |
| 4 | 8000 | 2000 | 75.705 | * | 2.8b | 2.0b | 3.8b | 3.5bc | 3.2a | 4.7ab |
| 5 | 12000 | 2000 | 75.705 | * | 1.3b | 2.8b | 4.0b | 4.3b | 2.8a | 3.0b |

In Experiment 1, after second application with BioCeresWB, the number of thrips on cucumber plants was reduced (leaf 4, leaf 6 and leaf 8 results in Table 4). A similar effect was observed at a later time (Table 4). As seen in FIG. 6, in average 4 thrips were observed on plants treated with BioCeres-WB while more than 12 thrips per leaf were observed on plants treated with water.

In Experiment 2. if is shown that BioCeres-WB treatment significantly reduced thrips density on cucumber plants in comparison with control treatment (Table 6). As shown on FIG. 6, thrips density on plants treated with BioCeres-WB was less than 5 thrips per leaf while more than 10 thrips per leaf were observed on plants treated with water.

In Experiment 3, after a 5th application, the number of thrips on BioCeres-WB treated plants was significantly lower than in control (Table 6). As shown on FIG. 7, in average 5 thrips per leaf were found on the plants treated with BioCeres-WB while more than 20 thrips per leaf ware observed on plants treated with water.

### EXAMPLE IV

### Use of Compacted Pesticide Formulation on Field-Grown Crops

BioCeres-WB (water dispersible briquettes) formulations of B. bassiana (strain ANT-03) were produced as indicated in Example I using 300 kg compaction force. Experiments were conducted in Quebec in 2010 against the tarnished plant bug (TPB) on field strawberry and lettuce and in British Columbia in 2011 against the strawberry aphid (SA). Fields crops were treated with BioCeres-WB or with an alternative chemical pesticide (Assail 70™ according to the label recommendations). Selected results are provided in Table 6.

TABLE 6
Selected results of pesticidal activity associated with the
application of BioCeres-WB to field-grown crops. Target insects:
TPB = Tarnished plant bug and SA = strawberry aphid.

| | BIOCERES-WB | | | Alternative pesticides | |
|---|---|---|---|---|---|
| | | | mean | | mean |
| | rate | No | efficacy | | efficacy |
| Crop/Pest | (g/L) | applic. | (%) | name | (%) |
| Field Lettuce/TPB | 4 | 1 | 85.7 | N/A | N/A |
| Filed Strawberry/TPB | 6 | 4 | 73.2 | N/A | N/A |
| Filed Strawberry/TPB | 4 | 5 | 79.2 | N/A | N/A |
| Field Strawberry/SA | 4 | 3 | 96.2 | Assail | 80.8 |
| | | | | 70 WP | |
| Field Strawberry/SA | 4 | 1 | 65.2 | Assail | 78.3 |
| | | | | 70 WP | |

### EXAMPLE V

### Disintegration Test for Effervescent Solid Composition (Tablets)

A single tablet was placed in a 1.5 L beaker containing 1 L of water at 20-22° C. Disintegration of the tablet occurres resulting in numerous bubbles of CO₂ gas. When the evolution of gas around the tablet or its fragments ceases, the tablet have disintegrated, being either dissolved or dispersed in the water so that no agglomerates remain. Table 7 disclose the viability of conidia in pellet formulation.

TABLE 7
Viability of conidia in pellet formulation at
4.3 kg, 6 kg, 15 kg and 16 kg hardness levels

| Treatment | Hardness level | Viability (%) |
|---|---|---|
| 1 | 4.3 kg | 92.5 |
| 2 | 6 kg | 79.1 |
| 3 | 15 kg | 74.9 |
| 4 | 16 kg | 75.8 |
| Control | Conidia with same formulants, | 92.2 |
| | not compressed | |

At 4.3 kg hardness the product disintegration in 1.1 of water is 15-20 minutes.

While the invention has been described in connection with specific embodiments thereof, it will be understood that the scope of the claims should not be limited by the preferred embodiments set forth in the examples, but should be given the broadest interpretation consistent with the description as a whole.

What is claimed is:

1. A solid pesticidal composition comprising a microbial propagule disseminated within a dry-compacted water-dispersible agriculturally acceptable carrier.

2. The solid pesticidal composition of claim 1, wherein the concentration of the microbial propagule in the solid pesticidal composition is between about 18% to about 22% (w/w).

3. The solid pesticidal composition of claim 2, wherein the concentration of the microbial propagule in the solid pesticidal composition is about 20% (w/w).

4. The solid pesticidal composition of any one of claims 1 to 3, wherein the microbial propagule is hydrophobic.

5. The solid pesticidal composition of any one of claims 1 to 4, wherein the microbial propagule is a fungal propagule.

6. The solid pesticidal composition of claim 5, wherein the fungal propagule is from an entomopathogenic fungus.

7. The solid pesticidal composition of claim 6, wherein the fungal propagule is a conidia from the entomopathogenic fungus.

8. The solid pesticidal composition of claim 6 or 7, wherein the entomopathogenic fungus is from the species Beauveria.

9. The solid pesticidal composition of claim 8, wherein the entomopathogenic fungus is from the genus Beauveria bassiana.

10. The solid pesticidal composition of any one of claims 1 to 9, wherein the concentration of the water-dispersible agriculturally acceptable carrier in the solid pesticidal composition is between about 55% to 65% (w/w).

11. The solid pesticidal composition of claim 10, wherein the concentration of the water-dispersible agriculturally acceptable carrier in the solid pesticidal composition is about 62% (w/w).

12. The solid pesticidal composition of claim 10 or 11, wherein the agriculturally-acceptable carrier comprises a clay.

13. The solid pesticidal composition of claim 12, wherein the clay is a kaolin clay.

14. The solid pesticidal composition of any one of claims 1 to 13, further comprising a water dispersant disseminated within the dry-compacted water-dispersible agriculturally acceptable carrier.

15. The solid pesticidal composition of claim 14, wherein the concentration of the water dispersant in the solid pesticidal composition is between about 15% to about 20% (w/w).

16. The solid pesticidal composition of claim 15, wherein the concentration of the water dispersant in the solid pesticidal composition is about 17% (w/w).

17. The solid pesticidal composition of any one of claims 14 to 16, wherein the water dispersant comprises a starch.

18. The solid pesticidal composition of claim 17, wherein the starch is a corn starch.

19. The solid pesticidal composition of any one of claims 1 to 18, further comprising a binder disseminated within the dry-compacted water-dispersible agriculturally acceptable carrier.

20. The solid pesticidal composition of claim 19, wherein the concentration of the binder in the solid pesticidal composition is between about 0.5% to about 2% (w/w).

21. The solid pesticidal composition of claim 20, wherein the concentration of the binder in the solid pesticidal composition is about 1 % (w/w).

22. The solid pesticidal composition of any one of claims 19 to 21, wherein the binder is a gum.

23. The solid pesticidal composition of claim 22, wherein the gum is xanthan gum.

24. An aqueous sprayable liquid formulation for controlling pest comprising the solid pesticidal composition of any one of claims 1 to 23 dispersed in an aqueous solution.

25. The sprayable liquid formulation of claim 24, wherein the aqueous solution is water.

26. The solid pesticidal composition of any one of claims 1 to 9, wherein the concentration of the water-dispersible agriculturally acceptable carrier in the solid pesticidal composition is between about 15% to 30% (w/w).

27. The solid pesticidal composition of claim 26, wherein the agriculturally-acceptable carrier comprises both a clay and cellulose.

28. The solid pesticidal composition of claim 12, wherein the clay is between about 15% to 25% (w/w) and cellulose is between about 5% to 15% (w/w).

29. The solid pesticidal composition of any one of claims 26 to 28, further comprising a water dispersant disseminated within the dry-compacted water-dispersible agriculturally acceptable carrier.

30. The solid pesticidal composition of claim 29, wherein the concentration of the water dispersant in the solid pesticidal composition is between about 15% to about 30% (w/w).

31. The solid pesticidal composition of any one of claims 29 to 30, wherein the water dispersant comprises a starch and calcium carbonate.

32. The solid pesticidal composition of claim 31, wherein the starch between about 3% to 17% (w/w) and calcium carbonate is between about 10% to 15% (w/w).

33. The solid pesticidal composition of any one of claims 26 to 32, further comprising a disintegrating agent disseminated within the dry-compacted water-dispersible agriculturally acceptable carrier.

34. The solid pesticidal composition of claim 29, wherein the concentration of the disintegrating agent in the solid pesticidal composition is between about 20% to about 30% (w/w).

35. The solid pesticidal composition of any one of claims 29 to 30, wherein the water dispersant comprises citric acid.

36. The solid pesticidal composition of any one of claims 26 to 35, further comprising a surfactant composition disseminated within the dry-compacted water-dispersible agriculturally acceptable carrier.

37. The solid pesticidal composition of claim 36, wherein the concentration of the surfactant composition in the solid pesticidal composition is between about 0.5% to about 7% (w/w).

38. The solid pesticidal composition of any one of claims 19 to 21, wherein the surfactant composition includes a surfactant and a lubricant.

39. An aqueous sprayable liquid formulation for controlling pest comprising the solid pesticidal composition of any one of claims 1 to 23 dispersed in an aqueous solution.

40. The sprayable liquid formulation of claim 39, wherein the aqueous solution is water.

41. A sprayable liquid formulation for controlling pest comprising an oil-in-water emulsion of the solid pesticidal composition of any one of claims 1 to 23.

42. The sprayable liquid formulation of claim 41 obtained by combining a mixture of an oil and a surfactant to the aqueous sprayable liquid formulation of claim 39 or 40.

43. The sprayable liquid formulation of claim 42, wherein the concentration of the oil in the mixture is between about 95 to about 98% (w/w) of the oil.

44. The sprayable liquid formulation of claim 42 or 43, wherein the oil is a rapeseed oil.

45. The sprayable liquid formulation of any one of claims 42 to 44, wherein the concentration of the surfactant in the mixture is between about 0.5 to 2% (w/w).

46. The sprayable liquid formulation of any one of claims 42 to 45, wherein the surfactant is a non-ionic surfactant.

47. The sprayable liquid formulation of claim 31, wherein the hydrophile-lipophile balance (HLB) of the sprayable liquid formulation is between about 8 to about 16.

48. The sprayable liquid formulation of claim 47, wherein the hydrophile-lipophile balance (HLB) of the sprayable liquid formulation is about 12.

49. The sprayable liquid formulation of any one of claims 42 to 49, wherein the surfactant comprises soy lecithin and/or a combination of Tween 80 and Span 80.

50. A method for controlling pest, said method comprising applying the sprayable liquid formulation of any one of claims 39 to 49 to a crop so as to limit or prevent pest growth and/or propagation

51. A process for producing a solid pesticidal composition, said process comprising:
a) providing a substantially homogeneous mixture comprising a microbial propagule and a water-dispersible agriculturally acceptable carrier; and
b) submitting the substantially homogeneous mixture of step a) to dry compaction to provide a dry-compacted solid pesticidal composition.

52. The process of claim 51, wherein, in step b), the dry-compacted solid pesticidal composition is a tablet.

53. The process of claim 51 or 52, wherein the dry compaction in step b) is performed at a compaction force of 250 to 500 kg, preferably 300 kg.

54. The process of any one of claims 51 to 53, wherein the concentration of the microbial propagule in the mixture is between about 18% to about 22% (w/w).

55. The process of claim 54, wherein the concentration of the microbial propagule in the mixture is about 20% (w/w).

56. The process of any one of claims 51 to 55, wherein the microbial propagule is hydrophobic.

57. The process of claim 56, wherein the microbial propagule is a fungal propagule.

58. The process of claim 57, wherein the fungal propagule is from an entomopathogenic fungus.

59. The process of claim 58, wherein the fungal propagule is a conidia from the entomopathogenic fungus.

60. The process of claim 58 or 59, wherein the entomopathogenic fungus is from the species Beauveria.

61. The process of claim 60, wherein the entomopathogenic fungus is from the genus Beauveria bassiana.

62. The process of any one of claims 51 to 61, wherein the concentration of the water-dispersible agriculturally acceptable carrier in the mixture is between about 55% to 65% (w/w).

63. The process of claim 52, wherein the concentration of the water-dispersible agriculturally acceptable carrier in the mixture is about 62% (w/w).

64. The process of claim 62 or 63, wherein the agriculturally-acceptable carrier comprises a clay.

65. The process of claim 64, wherein the clay is a kaolin clay.

66. The process of any one of claims 51 to 65, further comprising adding a water dispersant disseminated in the mixture.

67. The process of claim 66, wherein the concentration of the water dispersant in the mixture is between about 15% to about 20% (w/w).

68. The process of claim 67, wherein the concentration of the water dispersant in the mixture is about 17% (w/w).

69. The process of any one of claims 66 to 68, wherein the water dispersant comprises a starch.

70. The process of claim 69, wherein the starch is a corn starch.

71. The process of any one of claims 51 to 70, further comprising adding a binder to the mixture.

72. The process of claim 71, wherein the concentration of the binder in the mixture is between about 0.5% to about 2% (w/w).

73. The process of claim 72, wherein the concentration of the binder in the mixture is about 1% (w/w).

74. The process of any one of claims 71 to 73, wherein the binder is a gum.

75. The process of claim 74, wherein the gum is xanthan gum.
